(19) United States
(12) Patent Application Publication
(10) Pub. No.: US 2009/0074059 A1
(43) Pub. Date: Mar. 19, 2009

(54) ENCODING METHOD AND DEVICE FOR IMAGE DATA

(75) Inventor: Fang-Chen Chang, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX TECHNOLOGIES LIMITED, Tainan County (TW)

(21) Appl. No.: 11/856,732

(22) Filed: Sep. 18, 2007

(51) Int. Cl. H04N 7/24

(52) U.S. Cl. 375/240.03; 375/E07.016

(57) ABSTRACT

An encoding method for encoding image data comprising a plurality of pixels is disclosed. Each pixel corresponds to a pixel value. First coefficients in different frequencies which are transformed and quantized from a first set of pixel values are provided. Second coefficients in different frequencies which are transformed and quantized from a second set of pixel values are provided. A bitstream by encoding the first coefficients with interleaving the second coefficients according to a predetermined order is generated. The predetermined order to encode the first coefficients with interleaving the second coefficients is from the first coefficients and the second coefficients in the lowest frequency to the first coefficients and the second coefficients in the highest frequency.

### BACKGROUND OF THE INVENTION

1. Field of the Invention

The present invention relates to data compression, and in particular relates to methods for encoding image data.

2. Description of the Related Art

The rapid growth of digital imaging applications, including desktop publishing, multimedia, teleconferencing, and high-definition television (HDTV) has increased the need for efficient and standardized image compression techniques. Without image compression, the transmission of images would require an unacceptable bandwidth for many applications. As a result, methods of compressing images have been the subject of numerous research publications. Image compression schemes convert an image consisting of a two-dimensional array of pixels into a sequence of bits which are transmitted over a communication link. Each pixel represents the intensity of the image at a particular location therein. The transmission link may be an ordinary telephone line.

Consider an image comprising a gray-scale representation of a photograph at a resolution of 1000×1000 lines. Each pixel typically consists of 8 bits which are used to encode 256 possible intensity levels at the corresponding point on the photograph. Hence, without compression, transmission of the photograph requires that 8 million bits be sent over the communication link. A typical telephone line is capable of transmitting about 9600 bits per second; hence the picture transmission would require more than 10 minutes. Transmission times of this magnitude are unacceptable.

As a result, image compression systems are needed to reduce transmission time. It is also apparent to those skilled in the art that image compression systems may also be advantageously employed in image storage systems to reduce the amount of memory needed to store one or more images.

Transform coding is a type of image compression. Usually, image compression by transform coding requires three steps. In the first step, the image is transformed to a new representation in which the correlation between adjacent pixels is reduced. This transformation is usually completely reversible, that is, no information is lost at this stage. The number of bits of data needed to represent the transformed image is at least as large as that needed to represent the original image. The purpose of this transformation is to provide an image representation which is more ideally suited to known compression methods.

In the second step, referred to as quantization, each pixel in the transformed image is replaced by a value which is represented in fewer bits, on average, than the original pixel value. In general, the original gray scale is replaced by a new scale which has coarser steps and hence can be represented in fewer bits. The new gray scale typically has levels in which the different steps are of different sizes. The new gray scale is calculated from the statistical distribution of the pixel values in the transformed image.

In the third step, the quantized values are encoded by entropy encoding. Huffman coding and arithmetic coding are two of the most common entropy encoding techniques used. However, not all of the values in high frequencies are necessarily encoded in the entropy encoding step, compression rate determines whether all of the values in high frequencies are encoded or not. Usually, image data is encoded block by block. Each block comprises the quantized values in different frequencies. A following block is encoded after a block is finished being encoded. For encoding, the amount of bits after encoding is limited according to a predetermined compression rate. Therefore, the values in the blocks which are earlier encoded may be encoded completely in the beginning. On the other hand, after the encoded blocks exceed a maximum amount of bits available for encoding, the values in the blocks which are latter encoded may not be encoded completely. In the blocks which are latter encoded, the values in high frequencies are surrendered and only the values in low frequencies may be encoded. Accordingly, it may cause distortion of the compressed image data.

### BRIEF SUMMARY OF INVENTION

A detailed description is given in the following embodiments with reference to the accompanying drawings.

An encoding method for encoding image data comprising a plurality of pixels is disclosed. Each pixel corresponds to a pixel value. First coefficients in different frequencies which are transformed and quantized from a first set of pixel values are provided. Second coefficients in different frequencies which are transformed and quantized from a second set of pixel values are provided. A bitstream by encoding the first coefficients with interleaving the second coefficients according to a predetermined order is generated. The predetermined order to encode the first coefficients with interleaving the second coefficients is from the first coefficients and the second coefficients in the lowest frequency to the first coefficients and the second coefficients in the highest frequency. a₁, a₂, . . . , and aₘ are the first coefficients from the lowest frequency to the highest frequency, and b₁, b₂, . . . , and bₘ are the second coefficients from the lowest frequency to t the highest frequency, the order to encode the first coefficients with interleaving the second coefficients is a₁, b₁, a₂, b₂, a₃, b₃, . . . aₘ, bₘ.

An encoding method to encode image data of a plurality of pixels is disclosed. The image data is divided into a plurality of blocks, each block comprising a set of the pixels. The blocks are transformed to generate a plurality of sets of coefficients corresponding to the blocks in different frequencies according to a predetermined transform. Each of a first set and a second set is one of sets of coefficients, a₁, a₂, . . . , and aₘ are the coefficients from the lowest frequency to the highest frequency in the first set of coefficients, b₁, b₂, . . . , and bₘ are the coefficients from the lowest frequency to the highest frequency in the second set of coefficients The sets of coefficients are quantized. A bitstream is generated by encoding one of the sets of coefficients with interleaving another one of the sets of coefficients according to a predetermined order. The predetermined order to encode the one of the sets of coefficients with interleaving another one of the sets of coefficients is from the coefficients in the lowest frequency to the coefficients in the highest frequency. Thus, the order to encode the first set of coefficients with interleaving the second set of coefficients is a₁, b₁, a₂, b₂, a₃, b₃, . . . aₘ, bₘ.

An encoding device to encode image data of a plurality of pixels is disclosed. The encoding device comprises a transformation operator, a quantizer and a encoding operator. The transformation operator divides the image data into a plurality of blocks, each block comprises a set of the pixels, and transforms the blocks to generate a plurality of sets of coefficients corresponding to the blocks in different frequencies according to a predetermined transform. Each of a first set and a second set is one of sets of coefficients, a₁, a₂, . . . , and aₘ are the coefficients from the lowest frequency to the highest frequency in the first set of coefficients, b₁, b₂, . . . , and bₘ are the coefficients from the lowest frequency to the highest frequency in the second set of coefficients. The quantizer quantizes the sets of coefficients. The encoding operator generates a bitstream by encoding one of the sets of coefficients with interleaving another one of the sets of coefficients according to a predetermined order. The predetermined order to encode the one of the sets of coefficients with interleaving another one of the sets of coefficients is from the coefficients in the lowest frequency to the coefficients in the highest frequency. Thus, the order to encode the one of the first set of coefficients with interleaving the second set of coefficients is a₁, b₁, a₂, b₂, a₃, b₃, . . . aₘ, bₘ.

### BRIEF DESCRIPTION OF DRAWINGS

The present invention can be more fully understood by reading the subsequent detailed description and examples with references made to the accompanying drawings, wherein:

FIG. 1 is a diagram illustrating the coefficients in the encoding method in an exemplary embodiment of the invention;

FIG. 2 is a diagram illustrating the image compression device in an embodiment of the invention;

FIG. 3 is a diagram illustrating exemplary coefficients in an embodiment of the invention; and

FIG. 4 is a flowchart illustrating the encoding method disclosed in an embodiment of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

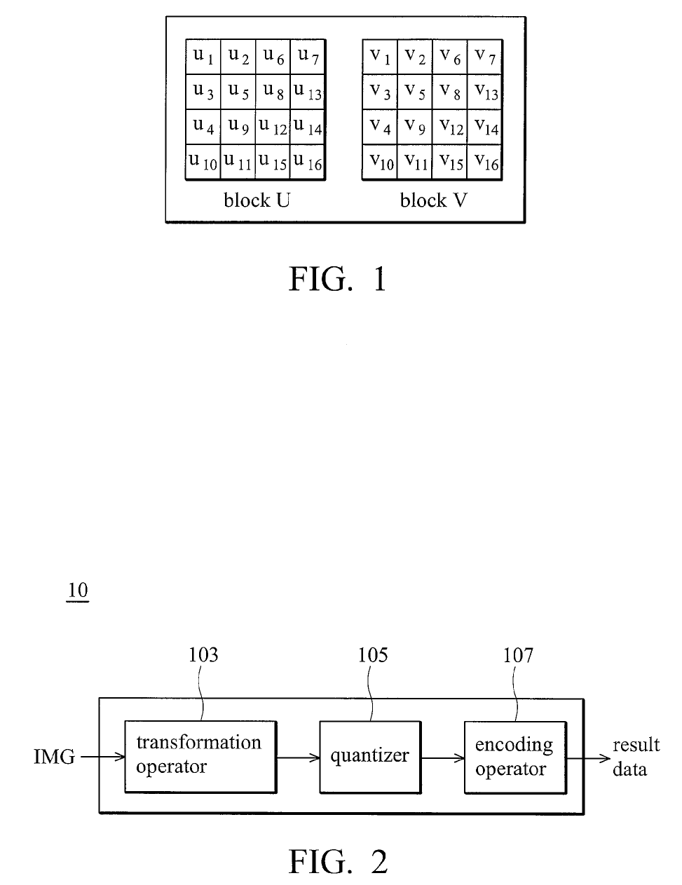

Image data IMG comprises a plurality of pixels. Each pixel corresponds to a pixel value where the pixels are arranged as a two dimensional array. Image data IMG is divided into a plurality of blocks. Each block comprises 16 pixel values corresponding to the pixels in image data IMG. After transforming and quantizing the pixel values in blocks by a predetermined transform method, such as discrete cosine transform (DCT) or discrete wavelet transform (DWT), the coefficients corresponding to the pixel values in blocks are respectively obtained. For example, pixel values in block U and block V, respectively correspond to the pixels in two adjacent blocks in image data IMG. Referring to FIG. 1, u₁˜u₁₆ are the coefficients in different frequencies corresponding to block U, and v₁˜v₁₆ are the coefficients in the different frequencies in block V. u₁ is the coefficient in the lowest frequency in block U of image data IMG, and u₁₆ is the coefficient corresponding to the highest frequency in block U of image data IMG. Similarly, v₁˜v₁₆ are the coefficients in the different frequencies in block V. Also, referring to FIG. 1, v₁ is the coefficient in the lowest frequency in block V of image data IMG, and v₁₆ is the coefficient in the highest frequency in block V of image data IMG. A bitstream is generated by encoding the coefficients in the blocks of image data IMG with block interleave. The coefficients in block U are encoded with interleaving the coefficients in block V. In addition, the coefficients are encoded starting at the coefficients in the lowest frequency to the coefficient in the highest frequency. As the aforementioned example, to encode block U with interleaving block V, the order to encode is u₁, v₁, u₂, v₂, u₃, v₃, . . . , u₁₆, v₁₆. However, due to the limitation of compression rate, length of the bitstream is limited. Thus, not all of the coefficients may be encoded completely. The encoding may be stopped at any coefficient when the length of the bitstream is off. For example, maybe only u₁, v₁, u₂, v₂, u₃, v₃, u₄ are encoded into the bitstream because of the limitation of compression rate. In another embodiment, only the coefficients before the last nonzero coefficients are encoded into the bitstream.

In another embodiment, pixel values in block U and block V, correspond to the pixels in the same block in image data IMG. For example, when the pixels are presented by RGB color model, the pixel values in block U are R values corresponding to the pixels, and the pixel values in block V are B values corresponding to the pixels.

FIG. 2 is a diagram illustrating the image compression device in an embodiment of the invention. Image compression device 10 comprises a transformation operator 103, a quantizer 105 and an encoding operator 107. In the beginning, transformation operator 103 receives image data IMG, and finally encoding operator 107 outputs a bitstream as result data.

First, transformation operator 103 divides image data IMG into a plurality of blocks, each block comprises a set of pixels in IMG. Each pixel corresponds to a pixel value. Transformation operator 103 performs a predetermined transformation, such as DCT, block by block, and generates a plurality of sets of coefficients corresponding to the pixel values of the sets of pixels. Then, quantizer 105 performs quantization on the sets of coefficients.

Next, encoding operator 107 generates the bitstream as the result data by encoding one of the sets of the quantized coefficients with interleaving another one of the sets of the quantized coefficients starting at the coefficient in the lowest frequency to the coefficient in the highest frequency as the aforementioned method. Finally, the bitstream is generated by block interleave.

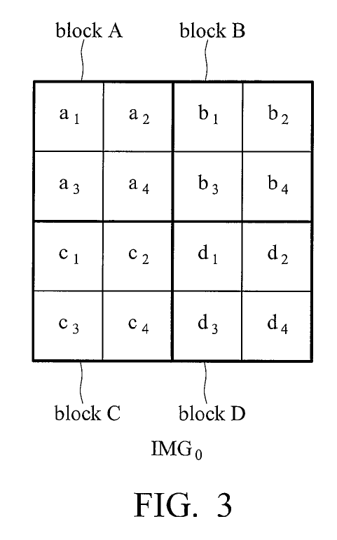

An image data IMG₀ comprises 16 pixels arranged as a 4×4 two dimensional array. IMG₀ is divided into four blocks, block A, block B, block C and block D. Each block comprises 4 pixels arranged as a 2×2 two dimensional array. The coefficients transformed and quantized from the blocks in image data IMG are as shown in FIG. 3. As the aforementioned method, the order for encoding IMG is a₁, b₁, c₁, d₁, a₂, b₂, c₂, d₂, a₃, b₃, c₃, d₃, a₄, b₄, c₄, d₄. In another embodiment, when a₃, b₂, c₃ and d₄ are all the last nonzero coefficients in the blocks, only the coefficients before the last nonzero coefficients are encoded, in another example, the coefficients a₄, b₃, b₄, c₄ are skipped for encoding. The order for encoding is a₁, b₁, c₁, d₁, a₂, b₂, c₂, d₂, a₃, c₃, d₃, d₄.

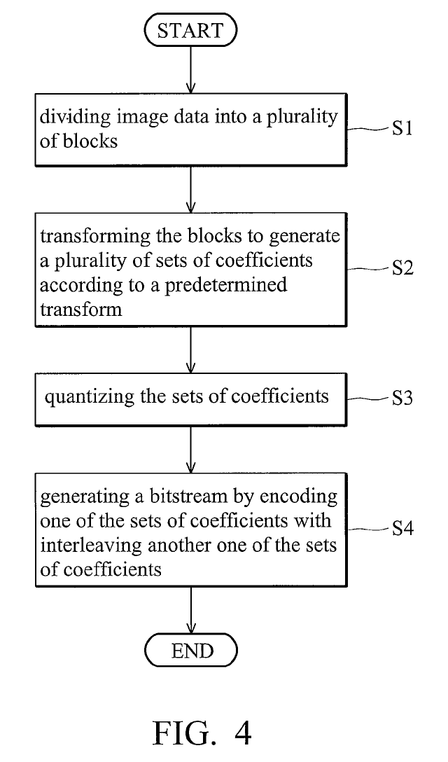

FIG. 4 is a flowchart illustrating the encoding method disclosed in an embodiment of the invention. Image data IMG is divided into a plurality of blocks, each block comprises a set of the pixels (S1). Each of a first set and a second set is one of sets of coefficients. The first set of coefficients and the second set of coefficients correspond to adjacent blocks in image data IMG. In another embodiment, the first set of coefficients and the second set of coefficients correspond to the same block in image data IMG. a₁, a₂, . . . , and aₘ are the coefficients from the lowest frequency to the highest frequency in the first set of coefficients. b₁, b₂, . . . , and bₘ are the coefficients from the lowest frequency to the highest frequency in the second set of coefficients. Next, the blocks are transformed to generate a plurality of sets of coefficients corresponding to the blocks in different frequencies. according to a predetermined transform, such as DCT. (S2). Then, the sets of coefficients are quantized (S3). Finally, a bitstream is generated as result data by encoding one of the sets of coefficients with interleaving another one of the sets of coefficients according to a predetermined order (S4). The predetermined order to encode the one of the sets of coefficients with interleaving another one of the sets of coefficients is from the coefficients in the lowest frequency to the coefficients in the highest frequency. In S4, the order to encode the first set of coefficients with interleaving the second set of coefficients is a₁, b₁, a₂, b₂, a₃, b₃, . . . aₘ, bₘ. In addition, when aᵢ is the last nonzero coefficient in the first set of coefficients from a₁ to aₘ, and bⱼ is the last nonzero coefficient in the second set of coefficients from b₁ to bₘ, only the coefficients in the first set of coefficients before aᵢ and the coefficients in the second set of coefficients before bⱼ are encoded to generate the bitstream.

As the above encoding method discloses, all the blocks in image data are equally encoded into the bitstream. Under the limitation of compression rate, the disclosed encoding method encodes the coefficients in low frequencies first for each block. And then the coefficients in high frequencies are encoded. Therefore, the distortion of the encoded result data may be decreased.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An encoding method, comprising:
providing first coefficients in different frequencies which are transformed and quantized from a first set of pixel values;
providing second coefficients in different frequencies which are transformed and quantized from a second set of pixel values;
generating a bitstream by encoding the first coefficients with interleaving the second coefficients according to a predetermined order.

2. The encoding method as claimed in claim 1, wherein the predetermined order to encode the first coefficients with interleaving the second coefficients is from the first coefficients and the second coefficients in the lowest frequency to the first coefficients and the second coefficients in the highest frequency.

3. The encoding method as claimed in claim 2, wherein a₁, a₂, . . . , and aₘ are the first coefficients from the lowest frequency to the highest frequency, and b₁, b₂, . . . , and bₘ are the second coefficients from the lowest frequency to t the highest frequency, the order to encode the first coefficients with interleaving the second coefficients is a₁, b₁, a₂, b₂, a₃, b₃, . . . aₘ, bₘ.

4. The encoding method as claimed in claim 3, wherein aᵢ is the last nonzero coefficient of the first coefficients from a₁ to aₘ, and bⱼ is the last nonzero coefficient of the second coefficients from b₁ to bₘ, only the first coefficients before aᵢ and the second coefficients before bⱼ are encoded to generate the bitstream.

5. The encoding method as claimed in claim 1, wherein the first set of pixel values and the second set of pixel values correspond to adjacent pixels in image data.

6. The encoding method as claimed in claim 1, wherein the first set of pixel values and the second set of pixel values corresponds to the same pixels in image data.

7. An encoding method to encode image data of a plurality of pixels, comprising:
dividing the image data into a plurality of blocks, each block comprising a set of the pixels;
transforming the blocks to generate a plurality of sets of coefficients corresponding to the blocks in different frequencies according to a predetermined transform;
quantizing the sets of coefficients;
generating a bitstream by encoding one of the sets of coefficients with interleaving another one of the sets of coefficients according to a predetermined order.

8. The encoding method as claimed in claim 7, wherein the predetermined order to encode the one of the sets of coefficients with interleaving another one of the sets of coefficients is from the coefficients in the lowest frequency to the coefficients in the highest frequency.

9. The encoding method as claimed in claim 8, wherein each of a first set and a second set is one of sets of coefficients, a₁, a₂, . . . , and aₘ are the coefficients from the lowest frequency to the highest frequency in the first set of coefficients, b₁, b₂, . . . and bₘ are the coefficients from the lowest frequency to the highest frequency in the second set of coefficients, the order to encode the first set of coefficients with interleaving the second set of coefficients is a₁, b₁, a₂, b₂, a₃, b₃, . . . aₘ, bₘ.

10. The encoding method as claimed in claim 9, wherein aᵢ is the last nonzero coefficient in the first set of coefficients from a₁ to aₘ, and bⱼ is the last nonzero coefficient in the second set of coefficients from b₁ to bₘ, only the coefficients in the first set of coefficients before aᵢ and the coefficients in the second set of coefficients before bⱼ are encoded to generate the bitstream.

11. The encoding method as claimed in claim 7, wherein the first set of coefficients and the second set of coefficients correspond to adjacent blocks in the image data.

12. The encoding method as claimed in claim 7, wherein the first set of coefficients and the second set of coefficients correspond to the same block in the image data.

13. An encoding device to encode image data of a plurality of pixels, comprising:
a transformation operator to divide the image data into a plurality of blocks, each block comprising a set of the pixels, and transform the blocks to generate a plurality of sets of coefficients corresponding to the blocks in different frequencies according to a predetermined transform;
a quantizer to quantize the sets of coefficients;
a encoding operator to generate a bitstream by encoding one of the sets of coefficients with interleaving another one of the sets of coefficients according to a predetermined order.

14. The encoding device as claimed in claim 13, wherein the predetermined order to encode the one of the sets of coefficients with interleaving another one of the sets of coefficients is from the coefficients in the lowest frequency to the coefficients in the highest frequency.

15. The encoding device as claimed in claim 14, wherein each of a first set and a second set is one of sets of coefficients, a₁, a₂, . . . , and aₘ are the coefficients from the lowest frequency to the highest frequency in the first set of coefficients, b₁, b₂, . . . , and bₘ are the coefficients from the lowest frequency to the highest frequency in the second set of coefficients, the order to encode the one of the first set of coefficients with interleaving the second set of coefficients is a₁, b₁, a₂, b₂, a₃, b₃, . . . aₘ, bₘ.

16. The encoding device as claimed in claim 15, wherein aᵢ is the last nonzero coefficient in the first set of coefficients from a₁ to aₘ, and bⱼ is the last nonzero coefficient in the second set of coefficients from b₁ to bₘ, only the coefficients in the first set of coefficients before aᵢ and the coefficients in the second set of coefficients before bⱼ are encoded to generate the bitstream.

17. The encoding device as claimed in claim 13, wherein the first set of coefficients and the second set of coefficients correspond to adjacent blocks in the image data.

18. The encoding device as claimed in claim 13, wherein the first set of coefficients and the second set of coefficients correspond to the same block in the image data.
